(19) United States
(12) Patent Application Publication
(10) Pub. No.: US 2008/0111047 A1
(43) Pub. Date: May 15, 2008

(54) RIGID MOUSE PAD

(75) Inventor: Louis Brown Abrams, Fort Collins, CO (US)

Correspondence Address: SHERIDAN ROSS PC, 1560 BROADWAY, SUITE 1200, DENVER, CO, 80202, US

(73) Assignee: HIGH VOLTAGE GRAPHICS, INC., Fort Collins, CO (US)

(21) Appl. No.: 11/940,287

(22) Filed: Nov. 14, 2007

Related U.S. Application Data
(60) Provisional application No. 60/865,785, filed on Nov. 14, 2006.
(60) Provisional application No. 60/869,671, filed on Dec. 12, 2006.

(51) Int. Cl. G06F 3/039

(52) U.S. Cl. 248/560; 248/346.01

(57) ABSTRACT

In one embodiment, the invention relates to a rigid computer mouse pad having a flocked “mousing” surface and a non-slip underside. The non-slip underside can be a second flocked surface.

### CROSS REFERENCE TO RELATED APPLICATIONS

The present application claims benefits of U.S. Provisional Patent Application Ser. No. 60/865,785, filed Nov. 14, 2006, and U.S. Provisional Patent Application Ser. No. 60/869,671, filed Dec. 12, 2006 both to Abrams, each of which is incorporated herein by reference.

### FIELD OF THE INVENTION

The invention relates generally to flocked articles, particularly to rigid, flocked articles. More particularly the invention relates to rigid mouse pad articles having a flocked “mousing surface” and a non-slip underside. In one particular embodiment, the non-slip material is a second flocked surface.

### BACKGROUND OF THE INVENTION

A computer mouse has become a standard computer peripheral, typically positioned and operated on a work surface as a point and command entering device, which controls with a relatively high level of precision the movement of a cursor over a computer monitor display screen. For instance, commands are entered by positioning the cursor on a displayed icon and depressing a button on the mouse. Typically, the use of a computer mouse enhances, compared to a keyboard entry, the speed and ease of inputting commands and/or data to a computer. A mouse pad is normally positioned between a work surface and the mouse to enhance the efficiency and precision of the mouse to respond to user commands and/or movements. FIG. 1A depicts a typical mouse pad 101 of the prior art made of a resilient, non-slip backing material 107, such as rubber with a smooth, knit or woven fabric and/or a polymeric material mousing surface 101 adhered to the backing material by a glue 103. FIG. 1B depicts another popular mouse pad, disclosed in U.S. Patent Application No. 2003/0129353 to Abrams, having a flocked mousing surface 102 adhered to a resilient, non-slip rubber backing material 106 by an adhesive 104.

The ability of a work surface to engage and interact with the mouse can profoundly impact the efficiency and precision of the mouse to respond to the user. For example, surfaces that do not properly “engage” the mouse position tracking device typically do not accurately and/or precisely control cursor movement or provide for efficient or accurate command entry. Additional problems may be encountered when a user seeks to operate the mouse without a rigid work surface. While the mouse pads of the prior art provide for frictional engagement between the mouse pad and work surface by the non-slip backing, the mouse pad is not sufficiently rigid to be operated when positioned on an uneven surface such as a user's lap.

Laptop computers have become popular, partly due to the convenience that they can be used almost anywhere, such as in bed, on a couch, in an armchair, or while sitting on the floor. Unfortunately, these are typically locations where the resilient mouse pads of the prior art cannot be positioned on a flat, horizontal rigid surface. When the mouse pads of the prior art are positioned on an uneven surface as depicted in FIG. 7A, such as in one's lap 70 or on the arm of a couch or chair, the resilient mouse pad conforms to the uneven surface. The mouse cannot properly contact the undulated mouse pad 101 of FIG. 7A, and the resulting mousing action will be erratic or not work at all. While tracking devices such as a “touch pad,” tracking balls, buttons, or keyboard entries and/or shortcut keys are available and do not require a mouse pad for operation, many people prefer the action of a mouse due to the “length of the mouse stroke” and the perceived superior hand-eye-screen response that a mouse provides compared to the a touch pad or button.

A rigid mouse pad can address these needs. The rigid mouse pad can be positioned on an uneven surface such as a user's lap 70 depicted in FIG. 7B or legs and provide an inherently rigid, flat surface 105 for optimal mouse response and the “mouse” feel and action. In addition, a non-slip surface on the rigid mouse pad can provide the added features of securely maintaining the rigid mouse pad in a stable and comfortable position on an uneven surface.

### SUMMARY OF THE INVENTION

In one embodiment, the present invention generally relates to a flocked rigid mouse pad and a method of manufacturing them with flock appliques. The rigid mouse pads can exhibit superior mouse pad surface performance, not only when positioned on flat, horizontal surfaces but particularly when positioned on uneven, unleveled, undulated, and/or non-horizontal surfaces. Rigid mouse pads do not conform to undulated surfaces as conventional pliable mouse pads do. The rigid mouse pad surface can engage the mouse consistently along the entire mouse stroke and allow for the mouse stroke length desired by users, not only when positioned on a conventional flat, horizontal surface but also when positioned on an undulated surface, such as, a user's lap or the arm of an armchair.

In one embodiment, the mouse pad has a flocked backing, desirably offering the user a plush, neutral, insulating feel when positioned in the user's lap. While not wanting to be bound by any theory the flock backing is more breathable than a rubber or foam backing. As will be appreciated, less breathable rubber and/or foam backings retain the user's body heat, causing the user to perspire in areas of contact with the mouse pad. The flocked backing can prevent user perspiration in these areas. The flock backing can also provide enhanced engagement with other textile materials, such as, with the user's clothing when the pad is on the user's lap, the textile upholstery when it is on an armchair or couch, or bed covers when the rigid mouse pad is used in bed. The flock backing can allow for a two-sided mouse pad, where each side of the mouse pad functions alternatively as a mousing surface or a non-slip backing and where each side can have a unique multicolor graphic design. By turning the pad over, the user can select the more desirable mouse surface graphic design.

In another embodiment, the present invention discloses a method of manufacturing a rigid mouse pad, where a flocked mousing surface, which may or may not be adhered to a foam layer, is adhered by a first tie-coat adhesive to a first surface of a rigid sheet material. Preferably, the flocked mousing surface contains a multicolored graphic. A second tie-coat adhesive is positioned between and adhered to a non-slip backing and a second surface of the rigid sheet. The first and second surfaces are in an opposing relationship. The flocked mousing surface and/or non-slip flock backing can be manufactured by any suitable method, including the methods disclosed by Abrams et al. in U.S. Pat. Nos. 4,810,549; 5,047,103; and 5,207,851 and in U.S. Patent Application Publication 2003/0129353 to Abrams.

The rigid mouse pad can be manufactured as a complete unit, having a flocked mousing surface, a rigid sheet material and a non-slip backing. Or, a rigid sheet assembly having a tie-coat adhesive and a non-slip backing is supplied separately to a customer, who adheres a separately supplied mouse pad to the rigid sheet assembly using the tie-coat adhesive.

### BRIEF DESCRIPTION OF THE DRAWINGS

FIGS. 1A and 1B are side views of mouse pads according to the prior art;

FIG. 2 is a cross-sectional side view of an embodiment of the present invention taken along line 2-2 of FIG. 4;

FIG. 3 is a cross-sectional view of an embodiment of the present invention taken along line 3-3 of FIG. 4;

FIG. 4 is a top view of an embodiment of an embodiment of the present invention;

FIG. 5 is a schematic flowchart of a manufacturing process according to an embodiment of the present invention;

FIG. 6 is a cross-sectional side view of another embodiment of the present invention;

FIG. 7A is view of a mouse pad of the prior art positioned in an user's lap;

FIG. 7B is a view of an embodiment of the present invention positioned in an user's lap;

FIG. 8 is a cross-sectional side view of another embodiment of the present invention;

FIG. 9 is a cross-sectional side view of another embodiment of the present invention; and

FIG. 10 is a cross-sectional side view of another embodiment of the present invention.

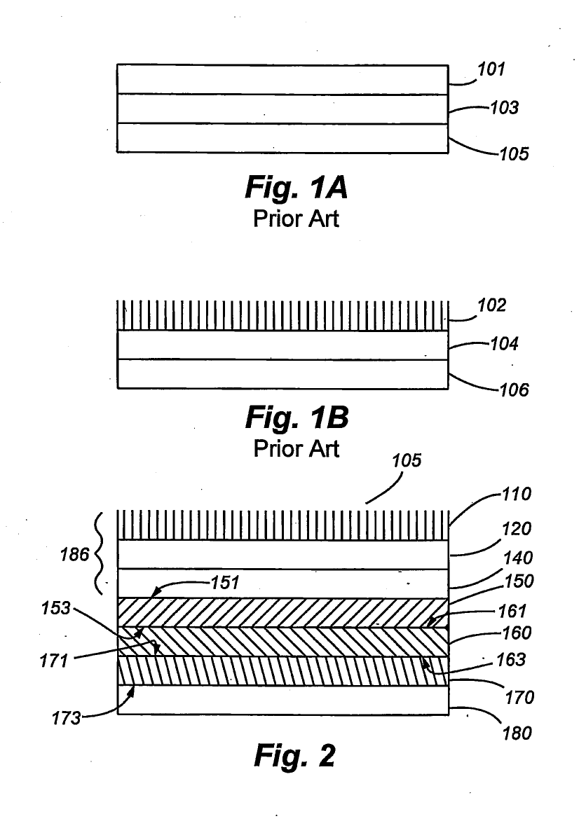

### DETAILED DESCRIPTION

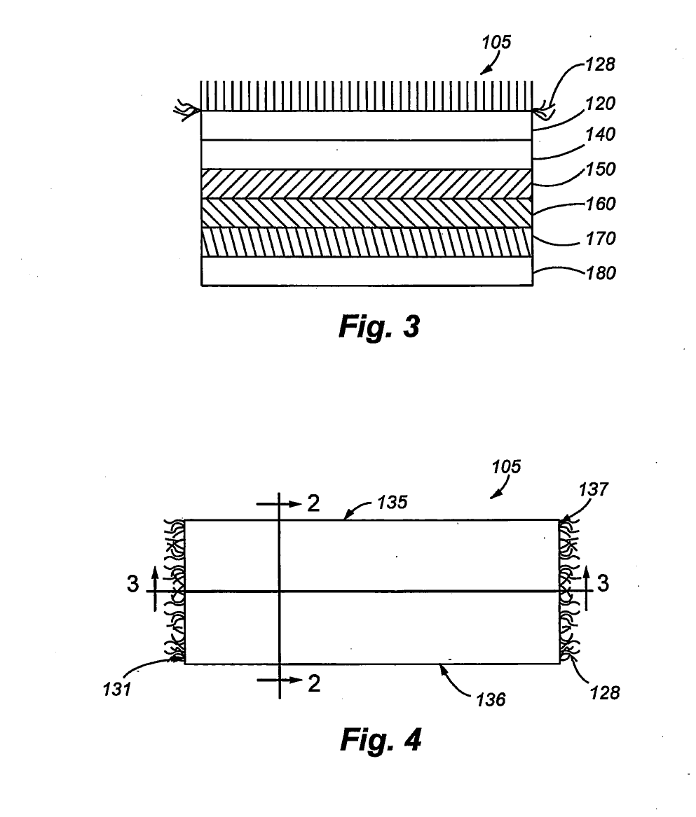

A first rigid mouse pad embodiment is shown in FIGS. 2-4. The rigid mouse pad article 105 comprises a flock assembly 186, a rigid sheet material 160 having a first side 161 and a second opposing side 163, a first adhesive layer 150 positioned between the flock assembly 186 and the first side 161 of the rigid sheet material 160 and a second adhesive layer 170 positioned between the second opposing side 163 of the rigid sheet material 160 and a non-slip material 180. The flock assembly 186 includes a third adhesive layer 120 positioned between a plurality of flock fibers 110 and a resilient layer 140. Referring to FIG. 4, the rigid mouse pad surface is substantially rectangular, having longer sides 135 and 136 and shorter sides 131 and 137. The mouse pad 105 can have fringe 128 added to the shorter sides 131 and 137 and/or longer sides 135 and 136 for aesthetic reasons. If used, is preferred to add fringe 128 at the interface of the flock fibers 110 and the resilient layer 140.

The flock fibers 110 can be any electrostatically chargeable fiber, such as fibers made from rayon, nylon, cotton, acrylic, and polyester. The flock fibers preferably are resilient and have a melting and/or softening point that is greater than the temperatures and pressures experienced in design, manufacturing, and later application processes to resist softening, deformation, and melting. Due to its low melt point, acrylic flock is undesirable in many applications. Resilient flock, such as rayon, nylon, and terephthalate (e.g., poly(cyclohexylene-dimethylene terephthalate) polymer flock, is particularly preferred. In most applications, the flock fiber orientation is substantially orthogonal (perpendicular) to the adhesive layer 120 and the flock fibers 110 are substantially parallel to one another. In one configuration, a conductive coating or finish is applied continuously or discontinuously over the exterior surface of the flock fibers to permit the flock fibers to hold an electrical charge. The flock fibers 110 generally display a multi-colored graphic and may be pre-colored (yam-dyed or spun dyed) or sublimation dye transfer printed, or colored or dyed by some other technique.

The third adhesive layer 120 can be any suitable water- or solvent-based adhesive. The adhesive is preferably a high temperature permanent adhesive, such as polybenzimidazoles and silica-boric acid mixtures or cements, hot-melt adhesives, thermosetting adhesives, thermoplastic adhesives, polyurethane, polyester, and combinations and blends thereof. Examples of thermosetting adhesives include acrylics, polyethylene, polyamides, epoxides, polyurethanes, phenolics, alkyds, amino resins, polyesters, epoxides, rubbers, and silicones.

The resilient layer 140 can be any deformable or elastic high polymer or elastomeric material, such as rubber or a rubber-like material. Examples include, without limitations, a polymeric foamed solid, a rubber material, a foamed rubber, an elastomeric rubber, or polychloroprene, or mixtures thereof. In a preferred embodiment the resilient layer 140 is an elastomeric polycholoroprene rubber.

The flock assembly 186 can be manufactured by any suitable method, including the methods disclosed by Abrams et al. in U.S. Pat. Nos. 4,810,549; 5,047,103; and 5,207,851 and in U.S. Patent Application Publication 2003/0129353 to Abrams.

The rigid sheet material 160 can be any substantially rigid or semi-rigid material, such as, but not limited to, plastic, metallic, botanical, or mineral materials. In one configuration, the substantially sturdy rigid sheet material is a material having a small deflection when a perpendicular force is applied to the material as it is suspended between two contact points. Preferably when a 5 Kg mass is placed on the material the deflection, at an equilibrium temperature of about 70° C., is at most about 2 mm and even more preferably at most about 1 mm.

Plastic materials are preferred for their rigidity, low specific gravity, economics and ease of use within the manufacturing process. More preferred is a high impact polycarbonate sheet material, with a polished surface, UV-stabilized, sheet polycarbonate material typically used in glazing and industrial applications for protection against accidental breakage. In an even more preferred embodiment, the rigid sheet material is a polycarbonate sheet, such as a thermoplastic, bisphenol A polycarbonate sheet. A particularly preferred polycarbonate sheet is a MAKROLON® GP polycarbonate sheet manufactured by Bayer Corp. Preferably, the MAKROLON® GP polycarbonate sheet having a thickness of at least about 0.02 inch, and even more preferably of about 0.08 inches.

Preferably, the rigid material has one or more of the following physical properties: a specific gravity (per ASTM D792) ranging from about 0.9 to about 1.4, with about 1.2 being more preferred; a refractive index (per ASTM D542) at 72° F. ranging from about 1.3 to about 1.9, with about 1.6 being more preferred; a light transmission value (per ASTM D1003) for a clear, ⅛ inch thickness polycarbonate sheet of at least about 75%, and even more preferably at least about 85%; a Rockwell Hardness (per ASTM D785) of about M70/R118; a water absorption value after 24 hours (per ASTM D570) ranging from about 0.1% to about 0.3%, with about 0.15% being more preferred; a melting point ranging from about 220-230° C.; and a softening point ranging from about 150-160° C.

When the rigid material is a polycarbonate sheet, the polycarbonate sheet preferably has one or more of the following mechanical properties: a yield tensile strength (per ASTM D638) ranging from about 7,000 to about 11,000 psi; an ultimate tensile strength (per ASTM D638) ranging from about 7,500 to about 11,500 psi; a tensile modulus (per ASTM D638) ranging from about 305,000 to about 385,000 psi; a flexural strength (per ASTM D790) ranging from about 10,500 to about 16,500 psi; a flexural modulus (per ASTM D790) ranging from about about 305,000 to about 385,000 psi; a compressive strength (per ASTM D695) ranging from about 9,500 to about 15,500 psi; a compressive modulus (per ASTM D695) ranging from about 305,000 to about 385,000 psi; an elongation (per ASTM D638) ranging from about 80 to about 140%; a poission's ratio ranging from about 0.2 to about 0.5; an izod notched impact strength (per ASTM D256) for a ⅛″ sheet ranging from about 9 to about 20 ft-lbs/in; an izod unnotched impact strength (per ASTM D256) for a ⅛″ sheet of no failures in the range of about 40 to about 80 ft-lbs/in; an instrumented impact (per ASTM D3763) for a ⅛″ sheet ranging from about 25 ft-lbs; a shear strength at yield (per ASTM D732) of ranging from about 4,000 to about 8,000 psi; an ultimate shear strength (per ASTM D732) ranging from about 7,000 to about 13,000 psi; and a shear modulus (per ASTM D732) ranging from about 84,000 to about 144,000 psi. In one configuration, the polycarbonate sheet has one or more of the following mechanical properties: a yield tensile strength of about 9,000 psi; an ultimate tensile strength of about 9,500 psi; a tensile modulus of about 345,000 psi; a flexural strength of about 13,500 psi; a flexural modulus of about 345,000 psi; a compressive strength of about 12,500 psi; a compressive modulus of about 345,000 psi; an elongation of about 110%; a poission's ratio of about 0.3; an izod notched impact strength for a ⅛″ sheet of at least about 12 to at most about 16 ft-lbs/in; an izod unnotched impact strength for a ⅛ inch sheet of no failures for at most about 60 ft-lbs/in; an instrumented impact for a ⅛ inch sheet of about 45 ft-lbs or higher; a shear strength at yield of about 6,000 psi; an ultimate shear strength of about 10,000 psi; and a shear modulus of about 114,000 psi.

The first and second adhesive layers, 150 and 170, respectively, can be any thermoplastic or thermosetting adhesive in the form of a solid, liquid or dispersion. Preferably, the first and second adhesives are translucent, opaque, or colored hot-melt or pressure sensitive adhesives. More preferably the first and second adhesives are pre-formed, self-supporting adhesive films. “Hot-melt” means any adhesive having a thermoplastic state when heated. Preferred hot-melt adhesives are substantially solvent-free adhesives such as, but not limited to, ethylene copolymers, polyamides, polyolefins, polyurethanes, and styrene block coploymers. “Pressure sensitive” means any contact adhesive that adheres to a surface with slight pressure, such as when applied by hand with a light “touching” pressure. Preferred pressure sensitive adhesives include acrylic and methacrylate adhesives, natural rubber adhesives, synthetic rubber adhesives, elastomeric adhesives, styrene copolymer adhesives, polyurethane adhesives, and silicone adhesives. In one configuration, the first and second adhesives are tie-coat adhesives.

The non-slip material 180 can be any material that provides a coefficient of friction such that the mouse pad moves very little, if at all, under typical “mousing” conditions, which includes normal downward and non-normal, translational forces applied simultaneously to the mouse pad. Or stated another way, the sliding coefficient of friction between the non-slip material 180 and the surface that the non-slip material is positioned on is preferably of a large enough value that the non-slip material moves at most very little, if at all, in response to the non-normal, translational forces applied under typical “mousing” conditions. Non-limiting examples of preferred non-slip material 180 are: a natural and/or synthetic rubber material, an elastomeric rubber material, a polymeric foamed solid (e.g., neoprene); a foamed rubber; another flocked surface; a polychoroprene; a tacky material, such as a low strength adhesive, or a mixture of one or more thereof. The non-slip material 180 can be applied in a continuous or discontinuous fashion to the second adhesive layer 170. By way of example, the non-slip material may be a ribbed, chevron, or dotted pattern. The non-slip material may be applied to the second adhesive layer as shown or be formed by embossing techniques.

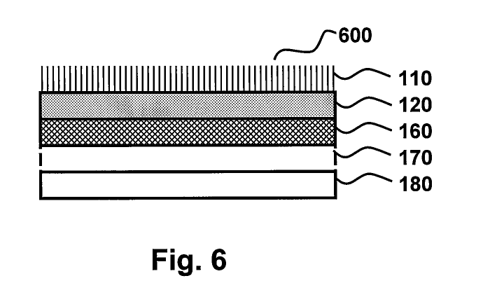

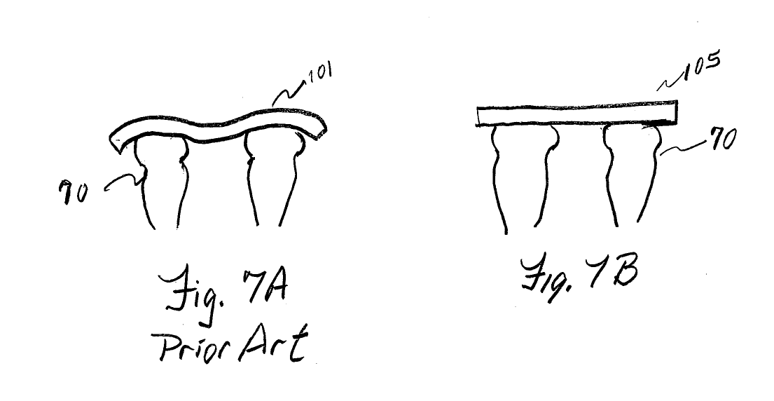

Another rigid mouse pad embodiment is shown in FIG. 6. The mouse pad 600 includes a plurality of flock fibers 110 adhered by the first adhesive layer 150 to the rigid sheet 160 and a non-slip material 180 adhered by the second adhesive layer 170 to the rigid sheet 160. Unlike the mouse pad of FIGS. 2-4, the mouse pad of FIG. 6 omits materials from the flock assembly 186, specifically the third adhesive layer 120 and resilient material 140. The mouse pad thus has the advantage over the mouse pad of FIGS. 2-4 of requiring less material and cost to manufacture and having a relatively small thickness. In one configuration, the thickness of the rigid mouse pad (from the external, outer surface of the flock fibers to the external, outer surface of the non-slip material) commonly ranges from about 1 mm to about 50 mm and even more commonly from about 1 to about 30 mm. The flock fibers 110 can be applied to the second adhesive layer 150 using a transfer (including a sacrificial carrier sheet and release adhesive) or by direct flocking techniques.

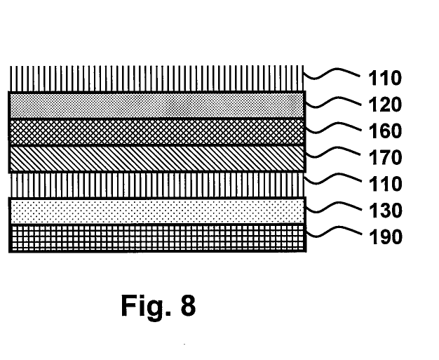

In one configuration, the non-slip material 180 is a flocked surface similar to the upper (mouse-contacting) flock surface. FIG. 8 shows a mouse pad according to this configuration. The flock fibers 110 are adhered permanently to the second adhesive layer 170. To manufacture the mouse pad, the flock fibers 110 are adhered temporarily to a release adhesive layer 130 coated on a sacrificial carrier sheet 190 that holds the flock fibers 110 until the fibers 110 are permanently adhered to the second adhesive layer 170. The carrier sheet 190 and release adhesive layer 130 are then removed and reused or discarded.

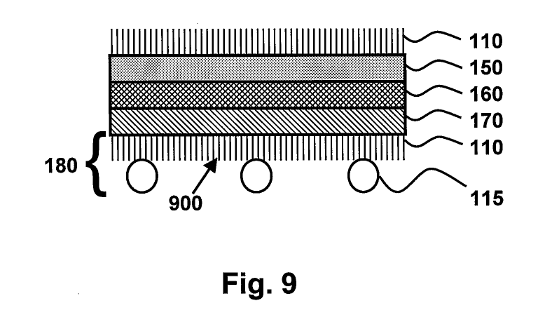

As shown in FIG. 9, the non-slip material 180 can include discrete or continuous non-slip regions 115, such as dots, applied to the flock fibers 110 at selected locations. The non-slip regions 115 provide additional slip resistance because, on certain surfaces (particularly on rigid or hard support surfaces), the flock fibers 110 can have insufficient slip or skid resistance for effective mousing to occur. In one design, the non-slip regions 115 are applied as a liquid to selected locations of flock and are therefore raised above the free ends 900 of the flock fibers. The liquid is tacky when dried and cured. A suitable material for a non-slip region is a monomeric, oligomeric, or polymeric resin, such as a urethane. As can be seen from FIG. 9, the non-slip regions 115 are generally applied to less than the entire surface area of the flock fibers 180. In this manner, flock fibers 110 are exposed for contacting softer surfaces, such as a body part or upholstery.

The combination of flock fibers 110 and non-slip regions 115 can be synergistic and highly versatile. The flock fibers 110 can provide not only slip resistance but also comfort to users using the mouse pad on softer surfaces, such as a body part or upholstered furniture. In such applications, the smaller non-slip regions 115 can further enhance slip resistance while only slightly impacting user comfort. The non-slip regions 115 can provide much higher levels of slip resistance on harder surfaces, such as desk and table tops, than the flock fibers 110 alone.

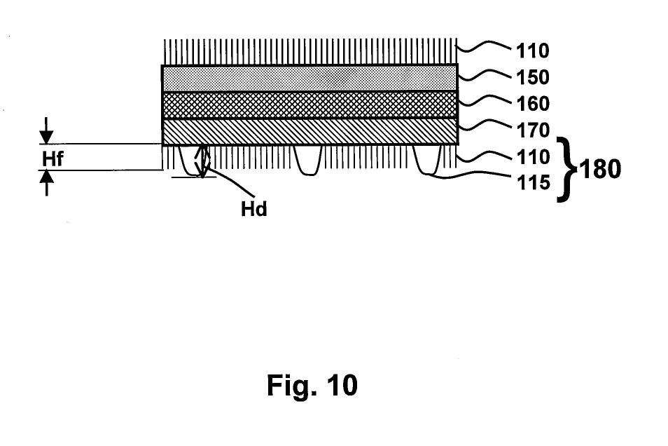

FIG. 10 depicts an alternate configuration in which the non-slip regions 115 are applied to the second adhesive layer 170 along with the flock fibers 110. The height Hd of the non-slip regions 115 is at least equal to the height Hf of the flock fibers 110 to elevate the flock fibers 110 so that they are even with or above the support surface. This embodiment is generally not preferred when the mouse pad is produced by lamination techniques. The elevated non-slip regions 115 can interfere with lamination.

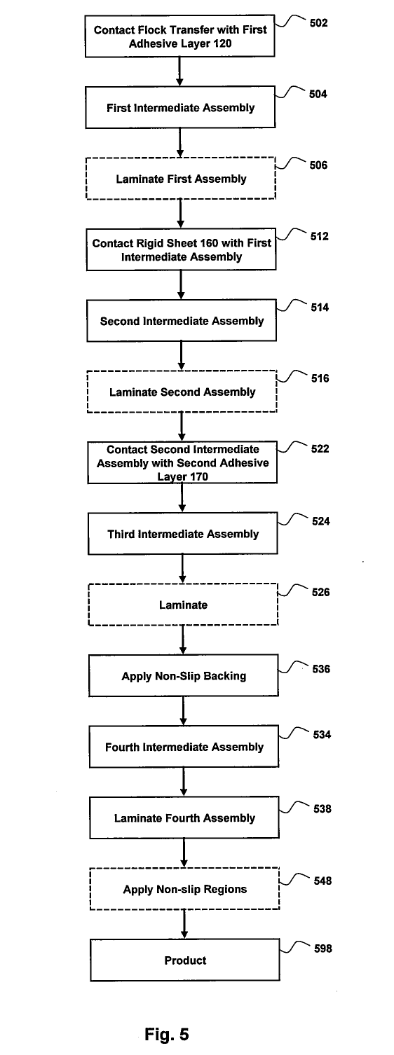

The system and process for manufacturing the mouse pad of FIG. 9 will now be discussed with reference to FIG. 5.

In step 502, a flock transfer is contacted with the first adhesive layer 120 to form a first intermediate assembly 504. The flock transfer includes flock fibers adhered by a release adhesive 130 to a sacrificial carrier sheet 190. In the first intermediate assembly 504, the first adhesive layer 120 is in contact with the free surface of the flock fibers 110. The first assembly can be held together, at least in part, by the tackiness or adhesive properties of the first adhesive layer 120 or by one or more mechanical properties of the manufacturing process.

In optional step 506, the various components of the first intermediate assembly 504 can be laminated together.

In step 512, the rigid sheet 160 is contacted with the first adhesive layer 120 of the first intermediate assembly 504 to form a second intermediate assembly 514. Because of the need to adhere the first adhesive layer 120 to the sheet 160, a thermosetting first adhesive layer 120 is commonly A-staged in optional lamination step 506.

In optional step 516, the various components of the second intermediate assembly 504 can be laminated together. In this step, a thermosetting first adhesive layer 120 can be B- and/or C-staged, as desired.

In step 522, the rigid sheet 160 of the second intermediate assembly 514 is optionally contacted with the second adhesive layer 170 to form a third intermediate assembly 524.

In optional step 526, the various components of the third intermediate assembly are laminated together. Because of the need to adhere the non-slip material 180 to the second adhesive layer, a thermosetting second adhesive layer is commonly A-staged in optional lamination step 526.

In step 536, the non-slip material or backing 180 is applied to the second adhesive layer of the third intermediate assembly 524 to form a fourth intermediate assembly 534.

In step 538, the various components of the fourth intermediate assembly 534 are laminated together.

In optional step 548, non-slip regions 115 are applied to the previously applied portion of the non-slip material to form the product 598.

As will be appreciated, the order of above steps may be reversed, certain of the steps performed simultaneously, and/or one or more of the steps omitted. By way of example, rather than using a flock transfer the flock fibers 110 can be flocked directly onto the first adhesive layer 120. As a further example, the non-slip backing 180 may be applied directly to the rigid sheet 160, thereby obviating the need for the second adhesive layer 170.

The operating conditions of the various laminating steps 506, 516, 526, and 538 can be the same or different. When the first adhesive 150 and/or the second adhesive 170 are the pressure sensitive adhesives, lamination is commonly performed by applying sufficient pressure to permanently adhere the pressure sensitive adhesive to the surface it is being adhered to. Preferably, the pressure applied ranges from about 1 psi to about 25 psi. When the first adhesive 150 and/or the second adhesive 170 are hot-melt adhesives, lamination is commonly performed by applying heat and pressure to the hot-melt adhesive. Preferably, the hot-melt adhesive is heated to a temperature to sufficiently soften or at least partially melt the hot-melt adhesive. While at elevated temperature, enough pressure is applied to cause the hot-melt adhesive to flow. More preferably, the hot-melt adhesive is heated to a temperature of at least about 150 degrees Fahrenheit and more preferably from about 175 to about 375 degrees Fahrenheit (or preferably the softening point of the hot-melt adhesive) while pressure, preferably of at least about 1 psi and more preferably ranging from about 5 to about 25 psi, is applied. It can be appreciated that the pressure applied can depend on the density of the flock fibers 110 and the resiliencies of the resilient layer 140 and the non-slip material 180.

A number of variations and modifications of the invention can be used. It would be possible to provide some features of the invention without providing others. For example, it can be appreciated that the flock assembly 186 can be provided with or without the resilient layer 140. The flock assembly can also be applied by direct flocking of the first adhesive layer 150, or by an in-mold flock transfer process, as for example, as disclosed in U.S. Pat. No. 6,929,771 or U.S. patent application Ser. Nos. 60/366,580, 60/393,580, 60/393,362, 60/416,098, and 60/433,986 all to Abrams. It can also be additionally that the rigid sheet 160, with or without the second adhesive layer 170, can be provided as an item of commerce where customers can adhere a mouse pad to the rigid sheet 160.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A computer mouse pad, comprising:
a rigid sheet having first and second opposing surfaces;
a plurality of flock fibers located adjacent to the first surface; and
a non-slip material located adjacent to the second surface.

2. The mouse pad of claim 1, wherein the non-slip material comprises flock fibers and further comprising
a first adhesive layer bonding the plurality of flock fibers to the first surface; and
a second adhesive layer bonding the non-slip material to the second surface.

3. The mouse pad of claim 2, wherein the second adhesive is one of a hot-melt adhesive or a pressure sensitive adhesive.

4. The mouse pad of claim 1, further comprising:
a resilient layer;
a first adhesive layer bonding the resilient layer to the rigid sheet;
a third adhesive layer bonding the plurality of flock fibers to the first surface.

5. The mouse pad of claim 4, further comprising:
a adhesive layer bonding the non-slip material to the second surface, wherein each of the first, second, and third adhesive layer is one of a thermosetting or thermoplastic adhesive.

6. The mouse pad of claim 1, wherein the non-slip material comprises second flock fibers and one or more non-slip regions applied to free ends of the second flock fibers.

7. The mouse pad of claim 1, wherein the rigid sheet is a polycarbonate.

8. The mouse pad of claim 7, wherein the rigid sheet is a thermoplastic, bisphenol A polycarbonate.

9. The mouse pad of claim 1, wherein the computer mouse pad has a thickness of no more than about 30 mm.

10. The mouse pad of claim 9, wherein the thickness of the rigid sheet is no more than about 0.25 inches.

11. The mouse pad of claim 1, wherein the non-slip material is selected from the group consisting essentially of: a polymeric foamed solid, a rubber material, a foamed rubber, an elastomeric rubber, a second plurality of flock fibers, a polychloroprene, and combinations thereof.

12. A method of manufacturing a rigid mouse pad article, comprising the steps of:
(a) adhering flock fibers to a first surface of a rigid sheet; and
(b) applying a non-slip material to a second surface of the rigid sheet, the first and second surfaces being in an opposing relationship.

13. The method of claim 12, wherein the flock fibers are adhered to the first surface of the rigid sheet by a first adhesive layer and wherein the non-slip material comprises second flock fibers adhered to the second surface of the rigid sheet.

14. The method of claim 13 further comprising:
(c) applying non-slip regions to at least some of the flock fibers.

15. The method of claim 12, wherein the rigid layer is a polycarbonate and wherein the non-slip material is selected from the group consisting essentially of: a polymeric foamed solid, a rubber material, a foamed rubber, an elastomeric rubber, a second plurality of flock fibers, a polychloroprene, and combinations thereof.

16. The method of claim 12, wherein a thickness of the mouse pad is no more than about 30 mm and wherein a thickness of the rigid sheet is no more than about 0.25 inches.

17. A computer mouse pad, comprising:
a first flocked surface for contacting a computer mouse; and
a second flocked surface for contacting a work surface, wherein the first and second flocked surfaces are opposing surfaces.

18. The mouse pad of claim 17, wherein the second flocked surface comprises a plurality of non-slip regions applied to a lower surface of the second flocked surface.

19. The mouse pad of claim 17, further comprising a rigid sheet positioned between the first and second flocked surfaces.

20. The mouse pad of claim 19, wherein a first-tie coat adhesive is positioned between the first flocked surface and the rigid sheet and a second-tie coat adhesive is positioned between the second flocked surface and the rigid sheet.
